(19) United States
(12) Patent Application Publication
(10) Pub. No.: US 2020/0342717 A1
(43) Pub. Date: Oct. 29, 2020

(54) FACILITATING SPORTS WAGERING BY GENERATING AND RESOLVING A SERIES OF WAGERING EVENTS IN REAL TIME, AND RELATED SYSTEMS, DEVICES, AND METHODS

(71) Applicant: IGT, Las Vegas, NV (US)

(72) Inventor: Dwayne NELSON, Las Vegas, NV (US)

(21) Appl. No.: 16/397,394

(22) Filed: Apr. 29, 2019

(51) Int. Cl. G07F 17/32

(52) U.S. Cl. CPC G07F 17/3288; G07F 17/3209; G07F 17/3244; G07F 17/3272

(57) ABSTRACT

A system, method, or device for facilitating a sports wagering game may include machine-readable instructions that cause a processor circuit to receive a first player input value from a player for a first wagering event of a sequence of wagering events of a wagering game, and resolve the first wagering event based on the first player input value for the first wagering event and an actual result of a first game event in a streaming sporting event associated with the first wagering event. The machine-readable instructions may further cause the processor circuit to receive a second player input value from the player for a second wagering event of the sequence of wagering events, and resolve the second wagering event based on the second player input value and an actual result of a second game event in the streaming sporting event associated with the second wagering event.

### BACKGROUND

Embodiments described herein relate to facilitating sports wagering, and in particular to facilitating sports wagering by generating and resolving a series of wagering events in real time, and related systems, devices, and methods. Live sporting events have many aspects that make them attractive to spectators, both from an entertainment standpoint and a wagering and/or betting standpoint. Live sporting events may be viewed in person, e.g., in a sports venue such as ballpark or stadium, or remotely, e.g., in a casino or other environment, via a television or other video display. As technology improves and as the competition for the attention of bettors and spectators increases, there is a need for additional interactive features that increase spectator involvement and excitement.

### SUMMARY

According to an embodiment, a system for facilitating a sports wagering game, the system includes a processor circuit and a memory coupled to the processor circuit. The memory includes machine-readable instructions that, when executed by the processor circuit, cause the processor circuit to receive a first player input value from a player for a first wagering event of a sequence of wagering events of a wagering game. The machine-readable instructions further cause the processor circuit to resolve the first wagering event based on the first player input value for the first wagering event and an actual result of a first game event in a streaming sporting event associated with the first wagering event. The machine-readable instructions further cause the processor circuit to receive a second player input value from the player for a second wagering event of the sequence of wagering events. The machine-readable instructions further cause the processor circuit to resolve the second wagering event based on the second player input value and an actual result of a second game event in the streaming sporting event associated with the second wagering event.

According to another embodiment, a method for facilitating sports wagering is disclosed. The method comprises, in response to a player placing a wager for a wagering game comprising a sequence of wagering events, sequentially resolving each wagering event of the sequence of wagering events. Resolving each wagering event comprises, for each wagering event, providing, by a processor circuit, a request to receive a player input value from the player for the wagering event. Resolving each wagering event further comprises determining, by the processor circuit, an actual result of a game event in a streaming sporting event associated with the wagering event. Resolving each wagering event comprises determining, by the processor circuit, a result of the wagering event based on the player input value for the wagering event and the actual result of the game event associated with the wagering event.

According to another embodiment, an electronic gaming device for facilitating a sports wagering game is disclosed. The electronic gaming device includes a display device, an input device, a processor circuit, and a memory coupled to the processor circuit. The memory includes machine-readable instructions that, when executed by the processor circuit, cause the processor circuit to receive a first player input value from a player for a first wagering event of a sequence of wagering events via the input device. The machine-readable instructions further cause the processor circuit to resolve the first wagering event based on the first player input value for the first wagering event and an actual result of a first game event in a streaming sporting event associated with the first wagering event. The machine-readable instructions further cause the processor circuit to receive a second player input value from the player for a second wagering event of the sequence of wagering events. The machine-readable instructions further cause the processor circuit to resolve the second wagering event based on the second player input value for the second wagering event and an actual result of a second game event in the streaming sporting event associated with the second wagering event.

### BRIEF DESCRIPTION OF THE DRAWINGS

FIG. 1 is a schematic block diagram illustrating a network configuration for a plurality of gaming devices according to some embodiments;

FIGS. 2A and 2B illustrate gaming device for facilitating sports wagering, including providing a sequence of wagering events, according to some embodiments;

FIGS. 3A-3C illustrate a graphical user interface for a gaming device for facilitating sports wagering, including providing a sequence of wagering events, according to some embodiments;

FIGS. 4A and 4B are flowcharts illustrating operations of systems/methods for facilitating sports wagering, according to some embodiments; and

FIG. 5 is a schematic block diagram illustrating various components of a computing device, according to some embodiments.

### DETAILED DESCRIPTION

Embodiments described herein relate to facilitating sports wagering, and in particular to facilitating sports wagering by generating and resolving a series of wagering events in real time, and related systems, devices, and methods. In some embodiments, the system receives a first player input value from a player for a first wagering event of a sequence of wagering events of a wagering game and resolve the first wagering event based on the first player input value for the first wagering event and an actual result of a first game event in a streaming sporting event associated with the first wagering event, The system then receives a second player input value from the player for a second wagering event of the sequence of wagering events, and resolves the second wagering event based on the second player input value and an actual result of a second game event in the streaming sporting event associated with the second wagering event.

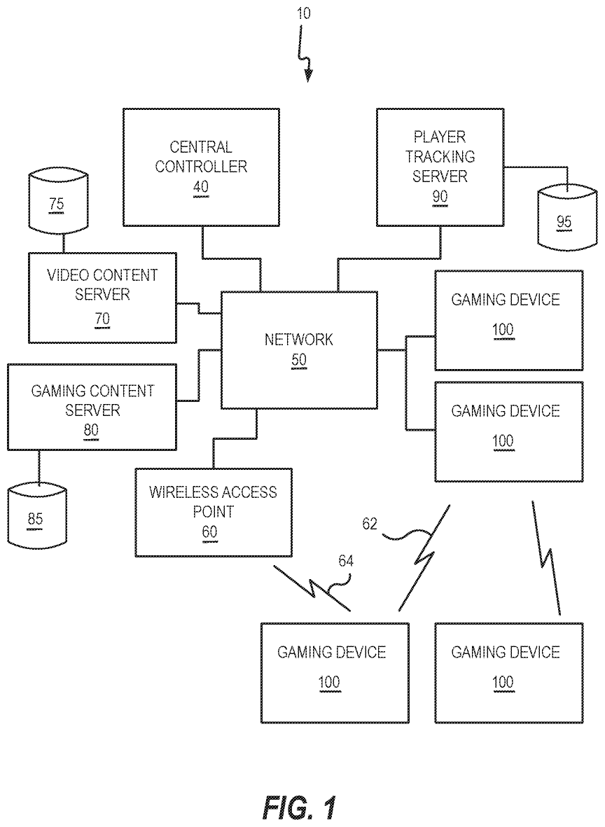

In this regard, FIG. 1 illustrates a system 10 including a plurality of gaming devices 100. The system 10 may be located, for example, on the premises of a gaming establishment, such as a casino, in a private residence, or may include components that are located at different locations. The gaming devices 100 may be in communication with each other and/or a central controller 40 through a data communication network 50, or remote communication link. The data communication network 50 may be a private data communication network that is operated, for example, by the gaming facility that operates the gaming device 100, a publicly accessible data communication network such as the Internet, or a combination thereof. Communications over the data communication network 50 may be encrypted for security. The central controller 40 may be any suitable server or computing device which includes at least one processing circuit, such as a processor, and at least one memory or storage device. Each gaming device 100 may include a processing circuit that transmits and receives events, messages, commands or any other suitable data or signal between the gaming device 100 and the central controller 40 and/or other gaming devices 100. The gaming device processor is operable to execute such communicated events, messages or commands in conjunction with the operation of the gaming device 100. Moreover, the processor of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processors. Moreover, in some embodiments, one or more of the functions of one or more gaming device processors as disclosed herein may be performed by the central controller 40.

A wireless access point 60 provides wireless access to the data communication network 50. The wireless access point 60 may be connected to the data communication network 50 as illustrated in FIG. 1, or may be connected directly to the central controller 40 or another server connected to the data communication network 50.

One or more content servers, such as a video content server 70 and a gaming content server 80, may also be connected through the data communication network 50. The video content server 70 may manage delivery of the streaming video content to a user of a gaming device 100. For example, the video content server 70 may distribute video of live sporting events, which may be received from a live video source, such as a broadcast, cable, or satellite provider. The streaming video content may also be recorded and stored in a video content database 75, and may be accessed as desired, e.g., on-demand. Similarly, the gaming content server 80 may manage delivery of the gaming content to the user of a gaming device 100. The gaming content may be stored in a gaming content database 85. The video content server 70 and a gaming content server 80 may be implemented within or separately from each other. The video content server 70 and a gaming content server 80 may also be implemented within or separately from the central controller 40.

A player tracking server 90 may also be connected through the data communication network 50. The player tracking server 90 may manage a player tracking account that tracks the gameplay and spending and/or other player preferences and customizations of a player, i.e., the user of the gaming device 100, manages loyalty awards for the player, manages funds deposited or advanced on behalf of the player, and other functions. Player information managed by the player tracking server 90 may be stored in a player information database 95.

The gaming devices 100 communicate with one or more elements of the system 10 to coordinate providing streaming video content and synchronized gaming content. For example, in some embodiments, a gaming device 100 may communicate directly with another gaming device 100 over a wireless interface 62, which may be a WiFi link, a Bluetooth link, an NFC link, etc. In other embodiments, the gaming device 100 may communicate with the data communication network 50 (and devices connected thereto, including EGMs) over a wireless interface 64 with the wireless access point 160. The wireless interface 64 may include a WiFi link, a Bluetooth link, an NFC link, etc. In still further embodiments, the gaming device 100 may communicate with other gaming devices 100 or other devices over the wireless interface 62 and the wireless access point 60 over the wireless interface 64. In these embodiments, the wireless interface 62 and the wireless interface 64 may use different communication protocols and/or different communication resources, such as different frequencies, time slots, spreading codes, etc. For example, in some embodiments, the wireless interface 62 may be a Bluetooth link, while the wireless interface 64 may be a WiFi link.

The wireless interfaces 62, 64 and/or wired interfaces may allow the gaming devices 100 and/or central controller 40 to coordinate providing streaming video content and synchronized gaming content to the gaming devices 100. In some embodiments, it may be desirable to providing streaming video content over a wired interface, which may have a higher bandwidth and lower latency than the wireless interfaces 62, 64, for example.

In some embodiments, the central controller 40, video content server 70 and/or gaming content server 80 may coordinate the generation and display of the streaming video content and the synchronized gaming content to more than one user and/or to more than one gaming device 100. As described in more detail below, this may enable multiple users to interact with the same streaming video content and/or gaming content in real time. This feature can be used to provide a shared multiplayer experience to multiple users at the same time. Moreover, in some embodiments, the central controller 40, video content server 70 and/or gaming content server 80 may coordinate the generation and display of the streaming video content and the synchronized gaming content to users at different physical locations.

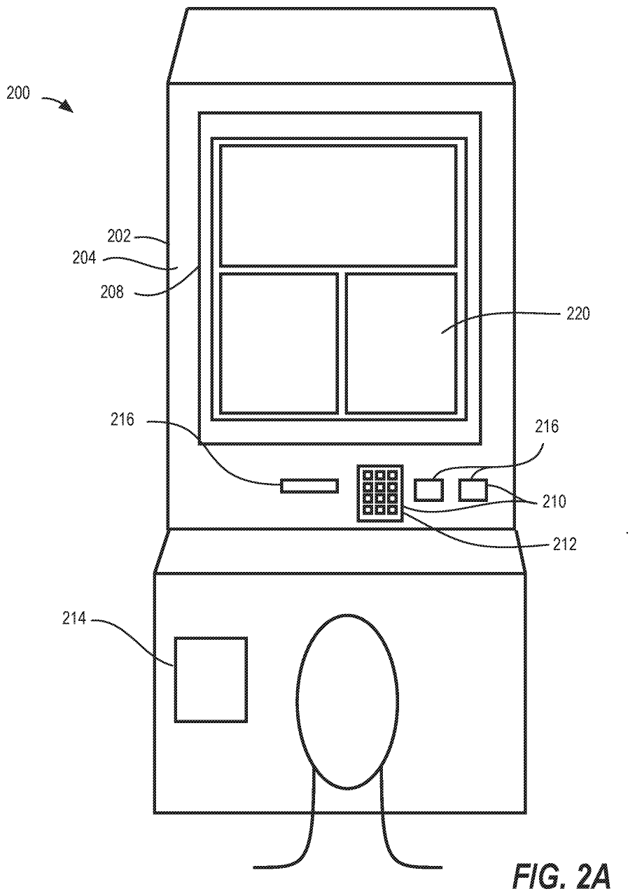

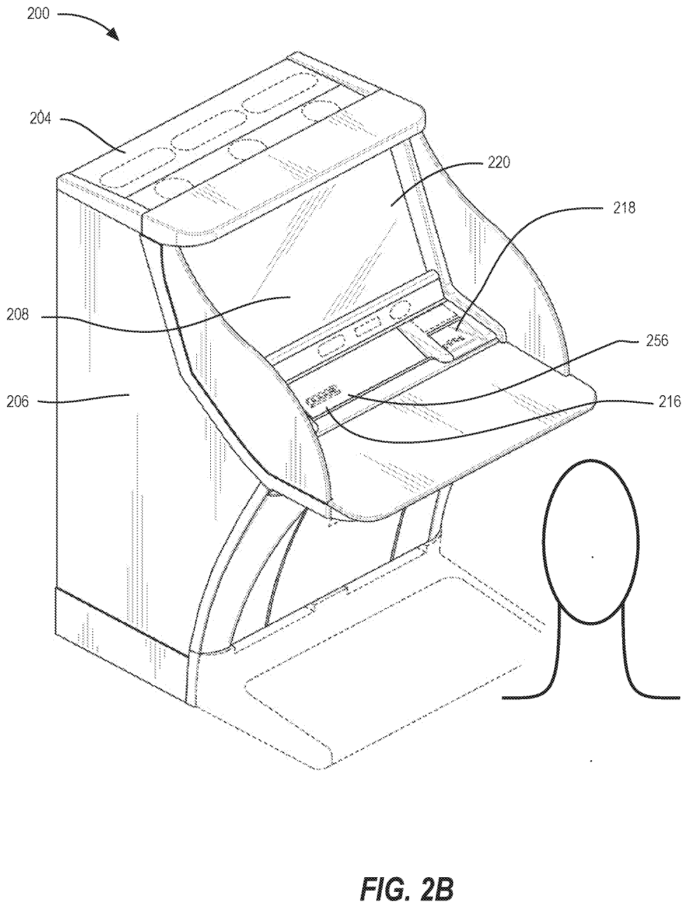

In this regard, FIGS. 2A and 2B illustrates gaming devices 200 for facilitating sports wagering according to some embodiments. As used herein, a gaming device may include, for example, an electronic gaming device such as a gaming terminal (such as a sports wagering terminal), an electronic gaming machine (EGM), etc., an electromechanical gaming device, a computing device such as a personal computer, a mobile computing device such as a tablet, smartphone, etc., or another device or devices. The gaming device 200 of FIG. 2A is an electronic gaming machine 202 and the gaming device 200 of FIG. 2B is a dedicated sports wagering terminal, but it should be understood that other types of gaming devices, such as mobile devices, for example, are contemplated. Referring now to FIG. 2A, the EGM 202 includes a housing 206 having a display device 208, and a plurality of input devices 210, such as a keypad 212, buttons 214, etc., for receiving user input for playing the wagering game and otherwise interacting with the EGM 202. In some embodiments, the display device 208 may include a touchscreen interface for receiving user input as well. The display device 208 may also be a single display device or may include multiple display devices, such as a first display device for displaying video of the live sporting event and a second display device for displaying gaming and wagering information for example. The EGM 202 may include additional specialized hardware as well, such as an acceptor 216, for receiving currency (i.e., bills and/or coins), tokens, credit or debit cards, or other physical items associated with monetary or other value. The EGM 202 may also include a dispenser 218, for dispensing items, such as physical items having monetary or other value (e.g., awards or prizes) or other items.

As will be discussed in detail below, the EGM 202 may include a processor circuit and a memory coupled to the processor circuit. The memory may include machine-readable instructions that, when executed by the processor circuit, cause the processor circuit to perform operations for operating the EGM 202 and/or other features described herein. In this example, the EGM 202 may include a graphical user interface (GUI) 220 displayed by the display device 208 for providing the video and gaming information to the player.

Referring now to FIG. 2B, the sports wagering terminal 204 may include many of the same or similar features as the EGM 202, such as a housing 206 having a display device 208 for displaying a GUI 220 (which may also include a touchscreen interface), and a plurality of input devices 256, an acceptor 216, for receiving currency (i.e., bills and/or coins), tokens, credit or debit cards, or other physical items associated with monetary or other value, and/or a dispenser 218, for dispensing items, such as physical items having monetary or other value (e.g., awards or prizes) or other items.

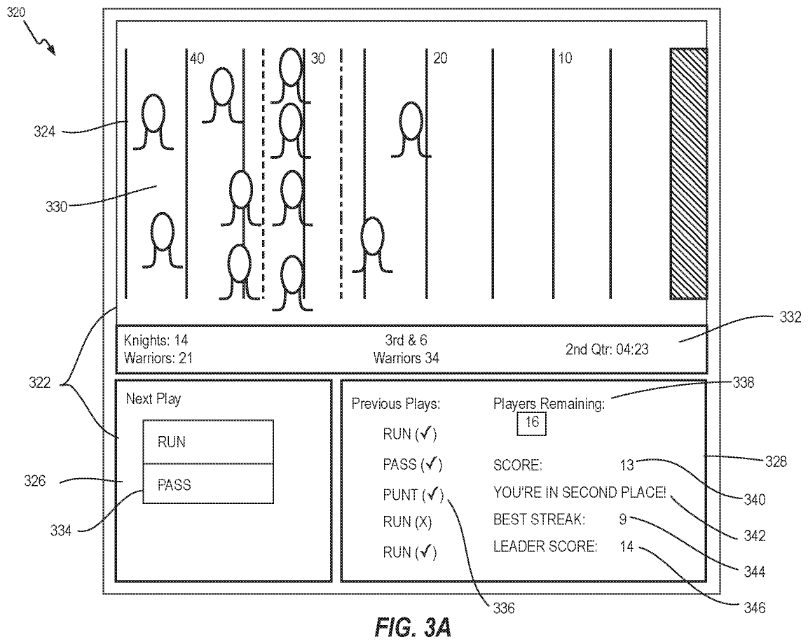

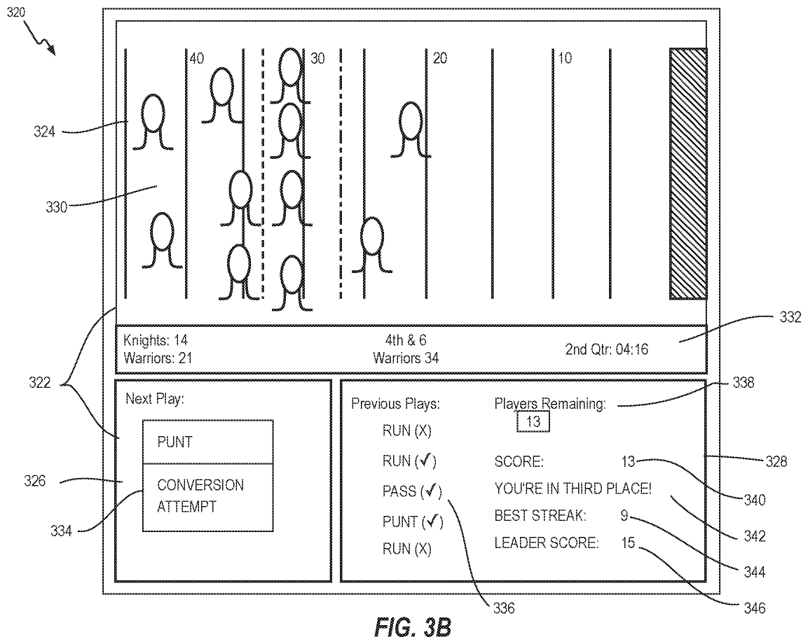

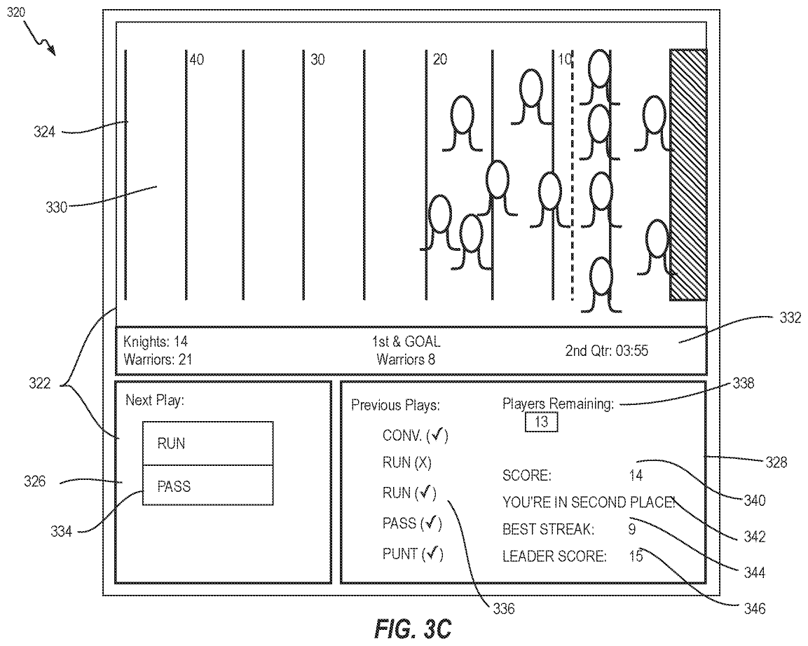

In this example, the GUI 220 of EGM 202 or the sports wagering terminal 204 may include features that facilitate sports wagering by generating and resolving a series of wagering events in real time or near real time. In this regard, FIGS. 3A-3C are diagrams of a GUI 320 for a gaming device including facilitating a wagering game, such as a sports wagering game, according to some embodiments. In this example, as shown by FIGS. 3A-3C, the GUI 320 is partitioned into different display areas 322, including a streaming video area 324, a control interface area 326, and a wager information display area 328. It should be understood, however, that additional features may be provided by the GUI 320, such as, e.g., multiple video windows, a casino gaming betting interface area, social game interface area, and/or a service window area, as desired.

In this example, the streaming video area 324 displays game video 330 and game information 332 for a streaming sporting event. In this example, the streaming sporting event is a live sporting event, but it should be understood that the streaming sporting event may be a pre-recorded sporting event, or a time-delayed sporting event. The streaming sporting event may alternatively be a simulated sporting event, in which some or all of the game events are simulated. The simulated game events may be generated randomly, semi-randomly, or in response to input from a player, such as the player of wagering game for example.

The control interface area 326 displays a sequence of wagering event selections 334, and receives player input values from the player for the sequence of wagering events. In some examples, displaying the wagering event selections 334 may also include a timeout function, in which a selection is made automatically if a player input is not received within a predetermined amount of time. For example, the selection options may be time-sensitive, e.g., dependent on actual events that will occur in the streaming sporting event. If the player steps away from the gaming device and/or is distracted, the selection can be made automatically so that the player does not forfeit the wagering game. In some embodiments, the automatic selections can be made randomly, semi-randomly, according to predetermined rules or preferences, etc.

The wager information display area 328 contains additional information about the wagering game, including results for previous wagering events 336, and a number of players remaining 338 in the game. For example, in some embodiments, play may continue until a predetermined number of players are eliminated. The wager information display area 328 may also contain information relating to a player's score 340, current rank 342 in the game, a current streak 344 of correct answers, and a current leader's score 346, etc.

Referring now to FIG. 3A, a player is presented with game video 330 of a live football game and game information 332 about the live football game, such as a current score, current play, time remaining, etc. in the video area 324. The control interface area 326 displays wager event selection 334 for the player to predict whether the next play will be a run play or a pass play, for example. It should be understood that the wager event selection 334 may be for any type of wagering event. In many embodiments, it may be desirable to present wager event selections 334 that may be resolved sequentially, and/or in quick succession, to increase the pace of play, and to increase player engagement and excitement. For example, because each play in the live football game involves a decision between a small set of possible types of play, e.g., run vs. pass, punt vs. conversion attempt, etc., the player in this embodiment is given the opportunity to participate in a large number of wagering events in a relatively short amount of time. These and other embodiments provide a technical solution to the uniquely challenging technical problem of providing multiple wagering opportunities for live sporting events and other sporting events in which multiple events occur in a relatively short amount of time.

In this example, the wager information display area 328 indicates that the player has a current streak of 3 correct answers in a row, and a total score of thirteen, putting the player in second place in a current field of sixteen remaining players. The leader has a score of fourteen, and the player's best streak is nine. Referring now to FIG. 3B, the wager information display area 328 indicates that the player incorrectly predicted that the previous play (which was the upcoming play in FIG. 3A) would be a run play, dropping his current rank to third place, with the leader score increasing to fifteen and one other player being eliminated to drop the number of remaining players to thirteen.

Referring now to FIG. 3C, the wager information display area 328 indicates that the player correctly predicted that the previous play (which was the upcoming play in FIG. 3B) would be a conversion attempt, returning his current rank to third place, with the leader score remaining at fifteen. In some embodiments, play will continue until a remaining player or group of players has been eliminated, with one or more prizes being awarded to the remaining player or group of players. In some embodiments, a player may be eliminated based on failing in a single wagering event of the sequence, or failing at a predetermined threshold number of wagering events of the sequence, for example.

Receiving a player input value may include the player selecting one of the options presented in the wager event selection, via a touchscreen interface, input device, or other method, for example. Resolving the wagering event is based on the player selection and an actual result of the game event, such as whether the next play will be a run or a pass, whether a particular team will advance or not, whether the team will gain at least a threshold number of yards on the next play, whether the team succeeds on a field goal or extra point, whether the quarterback goes left or right, which player will make the next play, etc. For the purposes of resolving the wagering event, the actual result of the game event may have different definitions depending on the parameters of the wagering event. For example, if a team gains six yards on a particular play, the actual result would be a gain of six yards for the purposes of resolving a wagering event where the player predicts the exact number of yards gained, or a range of up to six yards for resolving a wagering event where the player predicts the minimum number of yards gained. Based on the player input and the actual result of the game event, each wagering event may be sequentially resolved.

In some embodiments, the streaming sporting event may be a sport that includes changes in possession. In some embodiments, where a player is betting play-by-play on wagering events associated with a particular team, the player may continue betting on wagering events associated with that team for defensive player following the possession change, or may begin betting on the opposing team that now has possession. In one embodiment, the change in possession may end the wagering game, with the remaining players splitting the award pool, or with one of the remaining players being randomly chosen to be awarded the entire award pool. In some embodiments, the wagering game may only end when the change in possession is due to a team scoring, or alternatively, only when the change in possession is due to a turnover. In another embodiment, the change in possession ends the game as a loss for the player, so that the player must achieve the threshold score or streak to win the wagering game before the change of possession. A portion of the losing wager amount could remain for in the award pool for the next round or could be added to a progressive pool, which would cause the award pool to grow over time and increase player engagement and excitement.

In another embodiment, a player could bet on a particular game or a portion of a game (e.g., a period, half, possession, or period of time, etc.). In this example, the player could bet on the number of events in the game. For example, the player might bet that a team will run twelve times, pass six times, kick one field goal and score one touchdown in the first half.

In some examples, a subsequent wagering event may be based on and/or dependent from a result in a previous wagering event. For example, a request for a player input for the subsequent wagering event may be based on the player having a correct results or achieving a threshold minimum score in one or more previous wagering events. For example, if the player did not win the immediately previous wagering event, the player may be eliminated. In another example, the difficulty, odd, and/or payouts, etc. of subsequent wagering event may be adjusted based on the previous results.

In some examples, a player score value may be updated based on resolving each wagering event, which may include determining whether the player input value results in a winning result of the respective wagering event. Updating the player score may include increasing the player score value by a predetermined value. After resolving the plurality of wagering events, it may then be determined whether the player score value satisfies a predetermined threshold value to indicate a winning result for the wagering game.

In some examples, resolving the wagering game may include determining a maximum player score value of the plurality of respective player score values. The player associated with the maximum player score value may be awarded a prize. In some embodiments, in response to determining that a player input value does not correspond to the actual result of the game event, the player may be eliminated, with one or more remaining players at the end of the wagering game being awarded a prize.

Resolving a particular wagering event may include determining whether the player input value for the wagering event is equal to a result value associated with a winning result for the wagering event. Resolving a particular wagering event may also, or alternatively, include determining whether the player input value for the wagering event is within a predetermined range of values that includes a result value associated with a winning result for the first wagering event. Resolving a particular wagering event may also, or alternatively, include determining whether the player input value for the wagering event is nearer to a first result value associated with a winning result for the wagering event than another player input value of another player of the wagering game.

The player input value for each wagering event may include a selection, by the player, of one of a plurality of predetermined options, wherein each of the plurality of predetermined options corresponds to a prediction by the player of a future result for the game event. Alternatively, or in addition, the player input value for each wagering event may include an input, by the player, of a numerical value corresponding to a prediction by the player of a future result for the game event.

In some examples, the player may be required to make several user input selections for a sequence of wagering events in a relatively short period of time. This may result in the player being unable to make a decision in the time required for a particular wagering event. In some examples, the player may be awarded based on a total number of winning wagering events, rather than individual wins or losses. For example, if the player wins a first threshold number of wagering events or consecutive wagering events, the player may be awarded a first award, and if the player wins a larger second threshold number of wagering events or consecutive wagering events, the player may be awarded a larger second award. In some examples, the wagering events are based on simple decisions, such as predicting the next type of play, which allow for faster decision-making by the player. The player may be awarded based on a total number of winning wagering events, a streak of consecutive winning wagering events, or by outlasting a group other players in a knockout-style pool, in which a threshold number of losing wagering events causes the player to be eliminated. In some examples, the award may be a progressive award that increases as players make in-game bets. The progressive award could award when a player reaches a threshold number of correct decisions, a highest number of correct decisions in a certain time period, or reaches a threshold streak of consecutive correct decisions, for example. For example, a player might win the progressive award for having the highest win streak on a particular day or by beating the previous high score for the win streak. These and other awards may be a monetary award, such as cash or credit, or non-monetary, such as player points, goods or services, etc. In some examples, players and spectators may be able to view a leaderboard showing the ranking of streaks of good decisions made by player and the team they were betting on.

In some embodiments, if the player does not make a choice for a particular wagering event in time (e.g., before the play starts or before a timer expires), a selection can be made automatically for the player. The automatic selection can be chosen randomly, semi-randomly, based on a player's previous selection(s), and/or based on predetermined rules or player preferences, etc. In some embodiments, if the player does not make a choice for a particular wagering event in time, the player loses some or all of the wagering game.

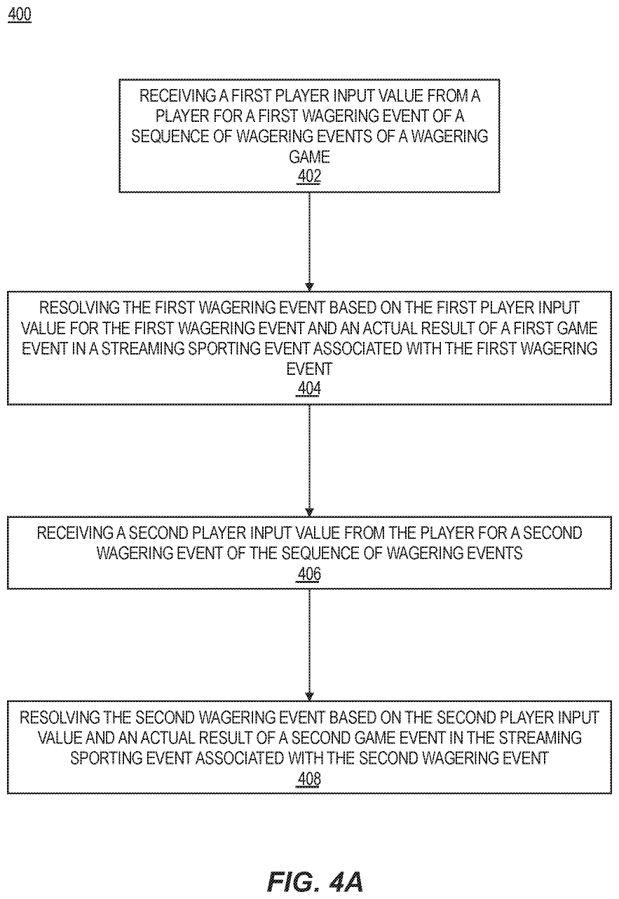

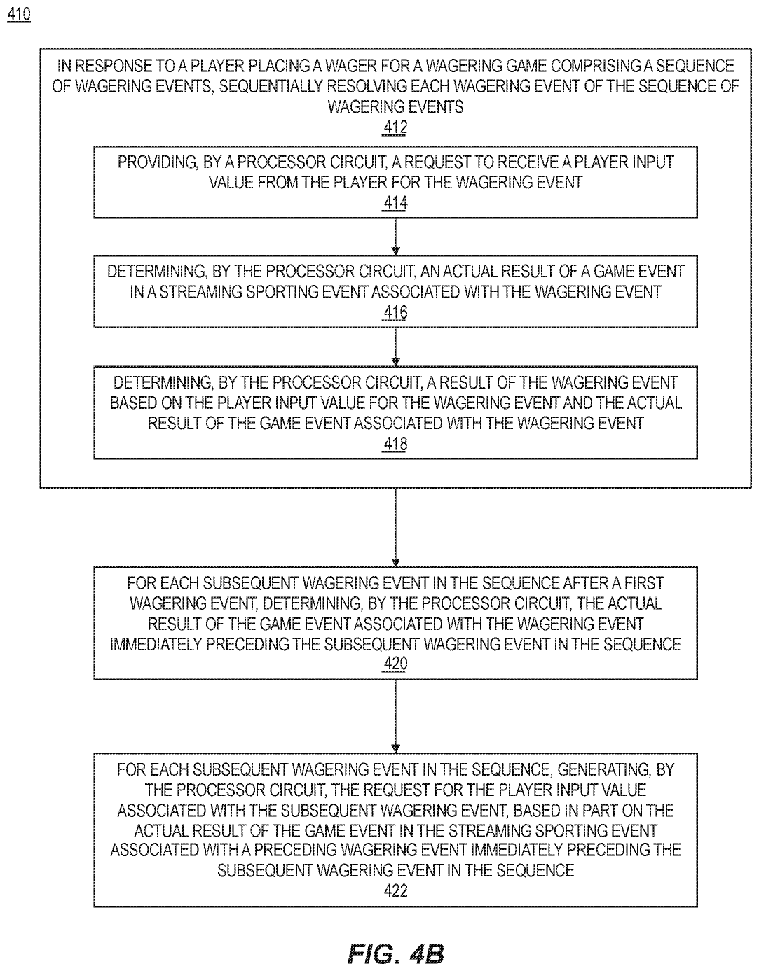

These and other features may be implemented as operations that may be executed by a processor circuit of a computing device. In this regard, FIG. 4A is a flowchart illustrating operations 400 of systems/methods according to some embodiments. The operations 400 may include receiving a first player input value from a player for a first wagering event of a sequence of wagering events of a wagering game (Block 402). The operations 400 may further include resolving the first wagering event based on the first player input value for the first wagering event and an actual result of a first game event in a streaming sporting event associated with the first wagering event (Block 404). The operations 400 may further include receiving a second player input value from the player for a second wagering event of the sequence of wagering events (Block 406). The operations 400 may further include resolving the second wagering event based on the second player input value and an actual result of a second game event in the streaming sporting event associated with the second wagering event (Block 408).

FIG. 4B is a flowchart illustrating operations 410 of systems/methods according to some alternative embodiments. The operations may include, in response to a player placing a wager for a wagering game comprising a sequence of wagering events, sequentially resolving each wagering event of the sequence of wagering events (Block 412). In this embodiment, resolving each wagering event includes providing, by a processor circuit, a request to receive a player input value from the player for the wagering event (Block 414). Resolving each wagering event further includes determining, by the processor circuit, an actual result of a game event in a streaming sporting event associated with the wagering event (Block 416). Resolving each wagering event further includes determining, by the processor circuit, a result of the wagering event based on the player input value for the wagering event and the actual result of the game event associated with the wagering event (Block 418).

The operations 410 may further include, for each subsequent wagering event in the sequence after a first wagering event, determining, by the processor circuit, the actual result of the game event associated with the wagering event immediately preceding the subsequent wagering event in the sequence (Block 420). The operations 410 may further include, for each subsequent wagering event in the sequence, generating, by the processor circuit, the request for the player input value associated with the subsequent wagering event, based in part on the actual result of the game event in the streaming sporting event associated with a preceding wagering event immediately preceding the subsequent wagering event in the sequence (Block 422).

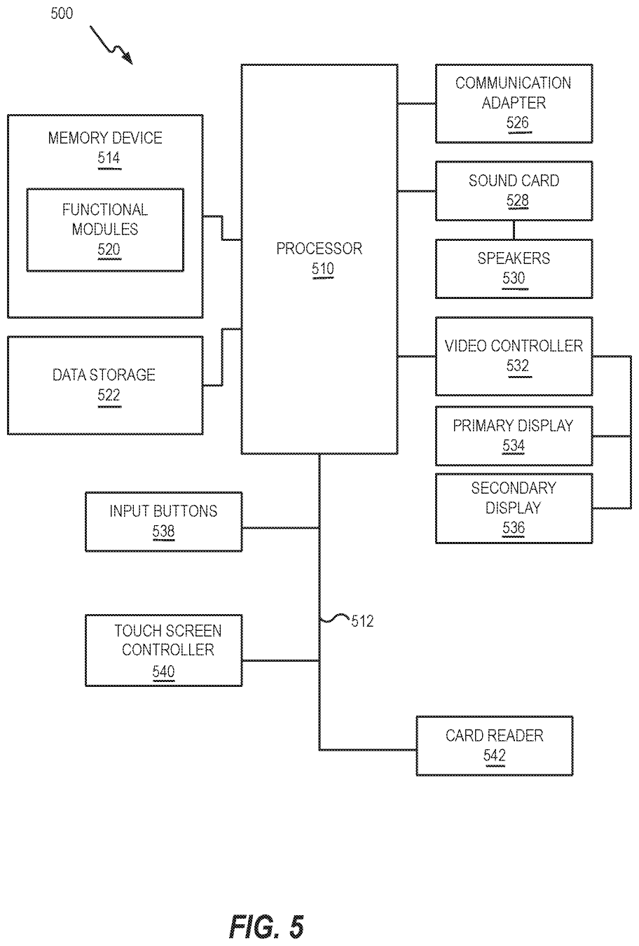

Referring now to FIG. 5, a block diagram that illustrates various components of a computing device 500, which may embody or be included as part of the devices, systems, and/or components above, according to some embodiments. As shown in FIG. 5, the computing device 500 may include a processor circuit 510 that controls operations of the computing device 500. Although illustrated as a single processor, multiple special purpose and/or general-purpose processors and/or processor cores may be provided in the computing device 500. For example, the computing device 500 may include one or more of a video processor, a signal processor, a sound processor and/or a communication controller that performs one or more control functions within the computing device 500. The processor circuit 510 may be variously referred to as a “controller,” “microcontroller,” “microprocessor” or simply a “computer.” The processor circuit 610 may further include one or more application-specific integrated circuits (ASICs).

Various components of the computing device 500 are illustrated in FIG. 5 as being connected to the processor circuit 510. It will be appreciated that the components may be connected to the processor circuit 510 and/or each other through one or more busses 512 including a system bus, a communication bus and controller, such as a USB controller and USB bus, a network interface, or any other suitable type of connection.

The computing device 500 further includes a memory device 514 that stores one or more functional modules 520 for performing the operations described above. Alternatively, or in addition, some of the operations described above may be performed by other devices connected to the network, such as the network 50 of the system 10 of FIG. 1, for example. The computing device 500 may communicate with other devices connected to the network to facilitate performance of some of these operations. For example, the computing device 500 may communicate and coordinate with certain displays to identify elements of a race being displayed by a particular display.

The memory device 514 may store program code and instructions, executable by the processor circuit 510, to control the computing device 500. The memory device 514 may include random access memory (RAM), which can include non-volatile RAM (NVRAM), magnetic RAM (ARAM), ferroelectric RAM (FeRAM) and other forms as commonly understood in the gaming industry. In some embodiments, the memory device 514 may include read only memory (ROM). In some embodiments, the memory device 514 may include flash memory and/or EEPROM (electrically erasable programmable read only memory). Any other suitable magnetic, optical and/or semiconductor memory may operate in conjunction with the gaming device disclosed herein.

The computing device 500 may include a communication adapter 526 that enables the computing device 500 to communicate with remote devices, such as the wireless network, another computing device 500, and/or a wireless access point, over a wired and/or wireless communication network, such as a local area network (LAN), wide area network (WAN), cellular communication network, or other data communication network, e.g., the network 50 of FIG. 1.

The computing device 500 may include one or more internal or external communication ports that enable the processor circuit 510 to communicate with and to operate with internal or external peripheral devices, such as a sound card 528 and speakers 530, video controllers 532, a primary display 534, a secondary display 536, input buttons 538 or other devices such as switches, keyboards, pointer devices, and/or keypads, a touch screen controller 540, a card reader 542, currency acceptors and/or dispensers, cameras, sensors such as motion sensors, mass storage devices, microphones, haptic feedback devices, and/or wireless communication devices. In some embodiments, internal or external peripheral devices may communicate with the processor through a universal serial bus (USB) hub (not shown) connected to the processor circuit 510. Although illustrated as being integrated with the computing device 500, any of the components therein may be external to the computing device 500 and may be communicatively coupled thereto. Although not illustrated, the computing device 500 may further include a rechargeable and/or replaceable power device and/or power connection to a main power supply, such as a building power supply.

In some embodiments, the computing device 500 may include a head mounted device (HMD) and may include optional wearable add-ons that include one or more sensors and/or actuators. Including ones of those discussed herein. The computing device 500 may be a head-mounted mixed-reality device configured to provide mixed reality elements as part of a real-world scene being viewed by the user wearing the computing device 500.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

1. A system comprising:
a processor circuit; and
a memory coupled to the processor circuit, the memory comprising machine-readable instructions that, when executed by the processor circuit, cause the processor circuit to:
generate a sequence of wagering events for a wagering game based, at least in part, on potential events which may occur in association with a streaming sporting event;
receive a first player input value for a first wagering event of a sequence of wagering events of a wagering game;
determine a result of the first wagering event based on the first player input value for the first wagering event and an actual result of a first game event in a streaming sporting event associated with the first wagering event;
based on the result of the first wagering event, modifying a second, subsequent wagering event in the sequence of wagering events;
receive a second player input value for the second wagering event of the sequence of wagering events; and
resolve the second wagering event based on the second player input value and an actual result of a second game event in the streaming sporting event associated with the second wagering event.

2. The system of claim 1, wherein the machine-readable instructions further cause the processor circuit to:
generate a request to receive the second player input value based in part on the actual result of the first game event in the streaming sporting event associated with the first wagering event.

3. The system of claim 2, wherein the machine-readable instructions further cause the processor circuit to:
generate, based in part on the actual result of the second game event, a request to receive a third player input value from the player for a third wagering event of the sequence of wagering events;
receive the third player input value from the player; and
resolve the third wagering event based on the third player input value and an actual result of a third game event in the streaming sporting event associated with the third wagering event.

4. The system of claim 1, wherein the machine-readable instructions further cause the processor circuit to:
for each wagering event in the sequence, update a player score value for the wagering game based on resolving the respective wagering event,
wherein the machine-readable instructions to determine the result of the first wagering event comprises machine-readable instructions to determine whether the first player input value results in a winning result for the first wagering event, and
wherein the machine-readable instructions to resolve the second wagering event comprises machine-readable instructions to determine whether the second player input value results in a winning result for the second wagering event.

5. The system of claim 4, wherein the machine-readable instructions to update the player score value for the first wagering event further comprises machine-readable instructions to, in response to determining that the first player input value for the first wagering event results in the winning result for the first wagering event, increase the player score value by a first predetermined value,
wherein machine-readable instructions to update the player score value for the second wagering event further comprises machine-readable instructions to, in response to determining that the second player input value for the second wagering event results in the winning result for the second wagering event, increasing the player score value by a second predetermined value, and
wherein the machine-readable instructions further cause the processor circuit to:
after resolving the sequence of wagering events, determine whether the player score value satisfies a threshold value.

6. The system of claim 1, wherein the machine-readable instructions further cause the processor circuit to:
determine, for each respective player of a plurality of players, a respective player score value based on resolving the sequence of wagering events for the respective player,
resolve the wagering game by determining a maximum player score value of the plurality of respective player score values; and
cause a prize to be awarded to the player associated with the maximum player score value.

7. The system of claim 1, wherein the machine-readable instructions further cause the processor circuit to:
for each wagering event of the sequence of wagering events, resolve the wagering event for each respective player of a plurality of respective players, wherein resolving the wagering event for each respective player comprises:
receiving a respective player input value from the respective player for the respective wagering event;
determining whether the respective player input value corresponds to the actual result of a respective game event in the streaming sporting event; and
in response to determining that the respective player input value does not correspond to the actual result of the respective game event, eliminating the respective player from the wagering game.

8. The system of claim 7, wherein the machine-readable instructions further cause the processor circuit to:
determine, after resolving the sequence of wagering events, a remaining player of the plurality of respective players that has not been eliminated.

9. The system of claim 1, wherein the machine-readable instructions to determine a result of the first wagering event further comprises the machine-readable instructions to determine whether the first player input value for the first wagering event is equal to a first result value associated with a winning result for the first wagering event.

10. The system of claim 1, wherein the machine-readable instructions to determine a result of the first wagering event further comprises the machine-readable instructions to determine whether the first player input value for the first wagering event is within a first predetermined range of values comprising a first result value associated with a winning result for the first wagering event.

11. The system of claim 1, wherein the machine-readable instructions to determine a result of the first wagering event further comprises machine-readable instructions to determine whether the first player input value for the first wagering event is nearer to a first result value associated with a winning result for the first wagering event than another first player input value of another player of a plurality of players of the wagering game.

12. The system of claim 1, wherein the first player input value comprises one of:
a selection of one of a plurality of predetermined options, wherein each of the plurality of predetermined options corresponds to a prediction of a future result for the first game event, and
an input of a first numerical value corresponding to a first prediction by the player of a first future result for the first game event.

13. (canceled)

14. The system of claim 1, wherein the streaming sporting event comprises one of a live sporting event, a simulated sporting event, and a recorded sporting event.

15. (canceled)

16. A method comprising:
analyzing a streaming sporting event to generate a sequence of wagering events for a wagering game based, at least in part, on potential events which may occur in association with the streaming sporting event;
for each wagering event of the sequence of wagering events,
prior to an occurrence of a game event in the streaming sporting event associated with the wagering event, receiving a first player input value for the wagering event at a first gaming device and a second player input value for the wagering event at a second gaming device;
determining an actual result of the game event in the streaming sporting event associated with the wagering event; and
determining, based on a comparison of the first player input value and the second player input value to the actual result of the game event, a result of the wagering event for the first gaming device and a result of the wagering event for the second gaming device;
eliminating the first gaming device from the wagering game based, at least in part, on the results for the first gaming device for the sequence of wagering events not satisfying a threshold; and
based on the first gaming device being eliminated, providing an award at the second gaming device.

17. The method of claim 16, further comprising:
for a first wagering event in the sequence of wagering events, determining a third player input value and an actual result of a game event associated with the first wagering event; and
based on the third player input value matching the actual result of the game event associated with the first wagering event, generating a request for a fourth player input value associated with a second, subsequent wagering event.

18. The method of claim 16, wherein determining the result of the wagering event for the first gaming device comprises determining whether the first player input value results in a winning result for the wagering event based, at least in part, on if the first player input value matches the actual result of the game event.

19. An electronic gaming device comprising:
a display device;
an input device;
a processor circuit; and
a memory coupled to the processor circuit, the memory comprising machine-readable instructions that, when executed by the processor circuit, cause the processor circuit to:
receive a sequence of wagering events for a wagering game generated based, at least in part, on potential events which may occur in association with a streaming sporting event;
receive a first player input value for a first wagering event of the sequence of wagering events via the input device;
determine an actual result of a first game event in the streaming sporting event associated with the first wagering event;
resolve the first wagering event based, at least on in part, on a comparison of the first player input value to the actual result of the first game event;
based on a determination that the first player input value matches the actual result of the first game event, generate a request to receive a second player input value from the player for a second wagering event of the sequence of wagering events; and
based on a determination that the first player input value does not match the actual result of the first game event, terminate the wagering game.

20. (canceled)

21. The electronic gaming device of claim 19, wherein the machine-readable instructions further cause the processor circuit to, for each wagering event of the sequence of wagering events which is resolved, increment a progressive award associated with the wagering game.

22. The electronic gaming device of claim 21, wherein the machine-readable instructions further cause the processor circuit to:
monitor a sequential number of winning results for the sequence of wagering events;
based on a determination that the sequential number of winning results satisfies a threshold, award the progressive award.

23. The method of claim 16, wherein the threshold is one of a number of losing results, a number of winning results, a point value, a winning streak value, and a losing streak value.
